(19) United States
(12) Patent Application Publication
(10) Pub. No.: US 2026/0229808 A1
(43) Pub. Date: Aug. 6, 2026

(54) MODULAR MULTI-TAP SYSTEM

(71) Applicant: Panduit Corp., Tinley Park, IL (US)

(72) Inventors: Andrew Crouse, Bolingbrook, IL (US); Jonathan Thompson, Woodridge, IL (US)

(73) Assignee: Panduit Corp., Tinley Park, IL (US)

(21) Appl. No.: 19/046,582

(22) Filed: Feb. 6, 2025

(51) Int. Cl. H01R 13/514

(52) U.S. Cl. CPC H01R 13/514

(57) ABSTRACT

A modular multi-tap system has a plurality of modules wherein each module of the plurality of modules has a metallic inner housing and a plastic outer housing. The plastic outer housing leaves the sides of the inner housing uncovered and has dovetail features which enable modules to be connected to each other in a manner that allows the uncovered sides of the inner housing to make metal-to-metal contact. The uncovered metallic sides may also have tongue and groove features to increase electrical contact

### FIELD OF INVENTION

The present disclosure relates generally to electrical muti-taps and more specifically to a modular muti-tap system.

### BACKGROUND

Multi-tap products are widely used in electrical infrastructure applications including solar applications. They can be found in ducts, troughs, raceways and boxes. Their main purpose is to connect several different wires that may be routed in different directions to a singular point. Wire conductors are inserted through wire port openings and held in place with a set screw.

Multi-taps have a minimum of two ports. Multi-taps with two, three and four ports are common, however there are some multi-taps with five, six, eight, ten, twelve and fourteen ports. The larger multi-taps are not used as often and therefore are not always in stock at a local distributor. In some applications, the amount of ports needed is not known until the installer arrives at the job site. In these cases, the installer needs parts in a very short time frame. If the required application requires more than four ports, the multi-tap may not be readily available.

### SUMMARY

A modular multi-tap system has a plurality of modules wherein each module of the plurality of modules has a metallic inner housing and a plastic outer housing. The plastic outer housing leaves the sides of the inner housing uncovered and has dovetail features which enable modules to be connected to each other in a manner that allows the uncovered sides of the inner housing to make metal-to-metal contact. The uncovered metallic sides may also have tongue and groove features to increase electrical contact.

### BRIEF DESCRIPTION OF THE DRAWINGS

FIG. 1 shows an isometric view of an inner aluminum housing.

FIG. 2 shows an exploded isometric view of an assembled module.

FIG. 3 shows an isometric view of two mating modules.

FIG. 4 shows the opposite isometric view of FIG. 3.

FIG. 5 shows a cross-sectional view of two mating modules.

FIG. 6 shows an isometric view of end-covers being added to the multi-tap.

FIG. 7 shows the opposite isometric view of FIG. 6.

FIG. 8 shows a cross-sectional view of fully installed multi-tap with wire.

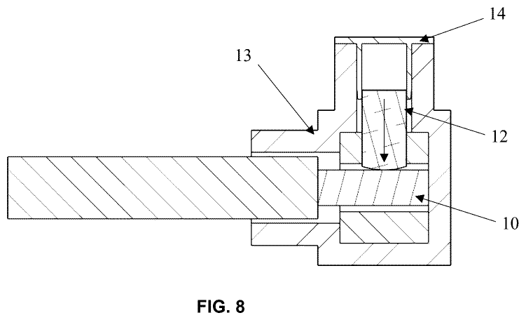

FIG. 9 shows an isometric view of a fully installed multi-tap with wire.

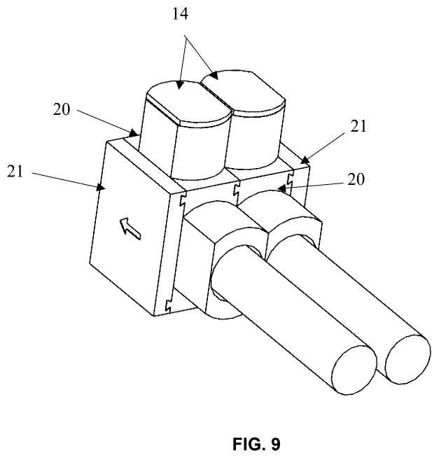

### DESCRIPTION OF INVENTION

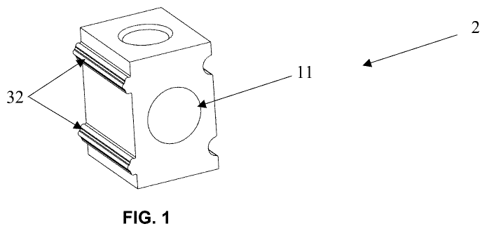

FIG. 1 shows an aluminum inner housing 2 with groove and tongue features 32, 34.

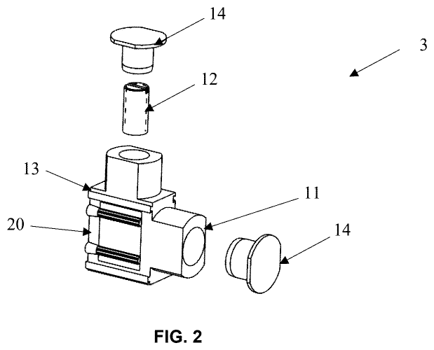

FIG. 2 shows an assembled module 3 in which the inner housing 2 is covered with plastic enclosures 13. The sides of the module (surfaces with the tongue and groove features) are not covered in plastic to allow for metal-to-metal contact between modules. Cap plugs 14 will keep out contaminates. Screw 12 will be used when installed with a wire. A plastic film, not shown, can be lightly adhered to the exposed aluminum to keep out contaminates.

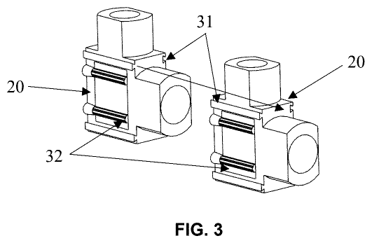

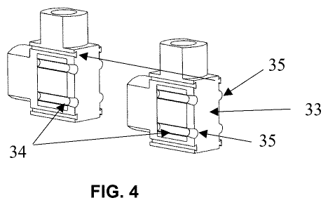

FIGS. 3 and 4 show two modules 3 being connected by sliding together. Cap plugs and screws are removed for clarity. The plastic enclosures 13 slide together with a dovetail arrangement 30, 31. The metal inner housings have tongues 32 that fit into a circular grooves 34. The tongue profile should have a minimum of two contact points for best electrical conductivity. The back of the plastic enclosure has a cone geometry 35. The cone geometry 35 in the end cover 21 will mate together to have a full contact surface to keep out dust and contaminates.

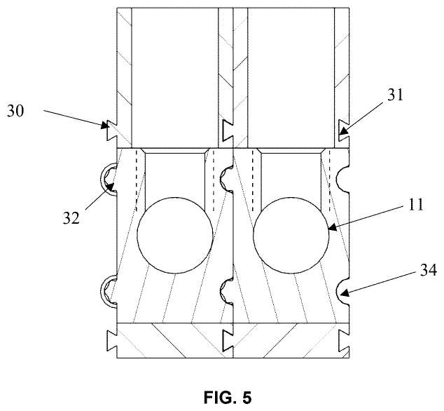

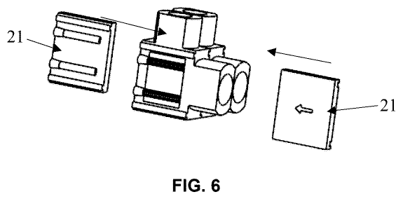

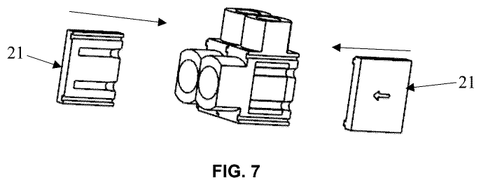

FIG. 5 shows the cross section of the two modules 3 together. This figure shows the interactions of the dovetail features 30,31 and the tongue and groove features 32, 34. FIGS. 6 and 7 show opposite views of end covers 21 being assembled to modular pieces 3. In the figures only two modular pieces are being installed together. But more than two modules may be assembled together in the present invention. Only one set of end covers would be required. One end cover will have the male tongue or dovetail which will fit on one end. The other side has the female grooves for the other end. Each part is assembled from one end of the port holes. These parts also have cone geometry ends that contacts the end cover.

The user can make any number of ports for the application with similar or different wire conductor size ranges. While the modular part shown in FIGS. 1 and 2 has one port, it is possible that one modular section could have multiple ports. Each part would consist of a normal modular assembly plus, a set of end covers.

Wire conductors 10 are inserted through wire port 11 openings and held in place with a set screw 12. The screw will be 90 degrees from the wire ports. Aluminum is the main material used for multi-taps. The aluminum can be tin plated after machining though in some cases it may be preferable to be plated in gold, silver, or some other metal. Typically, the multi-taps are covered in clear or opaque plastic enclosure 13 in order to insulate the multi-tap. Cap plugs 14 are inserted to the port holes to keep out contaminates. The wire ports are drilled for the largest conductor size, but smaller conductors can fit in them as well.

Two sides of the module 3 will have bare metal and not covered in plastic. In order for electricity to conduct between the modules, the surfaces must be metal-to-metal. More contact area is preferred. The metal-to-metal contact can be enhanced with tongue and groove features 32,34. The plastic pieces can have a traditional dovetail 30,31 feature. The metal-to-metal part ensures there are some rounded edge points of contact between the metal parts. The plastic-to-plastic parts are aligned to ensure the modules are held together tightly. The tight fit in the dovetail feature is to keep out dust and other contaminants while providing an electrical insulated part. The back end 33 of the plastic interfaces have chamfered sides that will ensure a tight fit. After the desired number of modules are installed, end covers are slid on to the side of the modules to ensure the metal surfaces are not exposed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A modular multi-tap system comprising a plurality of modules wherein each module of the plurality of modules has a metallic inner housing and a plastic outer housing, the plastic outer housing leaving the sides of the inner housing uncovered and having dovetail features which enable modules to be connected to each other in a manner that allows the uncovered sides of the inner housing to make metal-to-metal contact.

2. The modular multi-tap system of claim 1, wherein the uncovered sides of the inner housing have tongue and groove features to increase electrical contact between modules.

3. The modular multi-tap system of claim 1, further comprising at least one end cover configured to be secured to an uncovered side of a module.
